(19) United States
(12) Patent Application Publication
(10) Pub. No.: US 2007/0104224 A1
(43) Pub. Date: May 10, 2007

(54) Differentiated quality of service transport protocols

(76) Inventors: Keith Faulk Conner, Boonton, NJ (US); Anil M. Rao, Cedar Knolls, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/266,790

(22) Filed: Nov. 4, 2005

(51) Int. Cl. H04J 3/24

(52) U.S. Cl. 370/474

(57) ABSTRACT

A method for applying a differentiated Quality of Service (QoS) to a payload using a profile indicator that can identify or be used to identify portions of the payload having different QoS requirements. The profile indicator may be one or more length indicators for indicating the lengths of each portion of the payload, or it may be an index to a table which indicates the lengths of each portion of the payload. The table can be used to map the profile indicator to a number of portions in the packet, the lengths of each portion and a QoS requirement for each portion.

### FIELD OF THE INVENTION

The present invention relates generally to Internet Protocol (IP) applications and, in particular, to IP applications in a wireless communications system.

### BACKGROUND OF THE INVENTION

Network protocols, such as the well-known Open System Interconnection (OSI) reference model and the Internet Protocol (IP) protocol stack, include a transport layer which provides transparent transfer of data between hosts. Most transport layers, however, do not provide a mechanism for allowing multiple levels of Quality of Service (QoS) to be applied to the payload portion of a data packet. One transport layer which does allow for two levels of QoS is the User Datagram Protocol (UDP) Lite transport layer.

FIG. 1 depicts a Universal Mobile Telecommunications System (UMTS) based wireless communications system 100, internet 105 and a VoIP phone 110 using a protocol stack having the UDP Lite transport layer in accordance with the prior art. Wireless communications system 100 comprises at least Gateway GPRS Support Node (GGSN) 120, core network 130 and User Equipment (UE) 140. GGSN 120 being an interface between internet 105 and core network 130. Core network 130 includes Mobile Switching Center (MSC) 150, Radio Access Network (RAN) 160, Radio Network Controller (RNC) 170 and Node B 180. In some system deployments, VoIP phone 110 may be an electronic device that converts a Public Switched Telephone Network (PSTN) call into a VoIP call, or a PSTN or wireless network may have an inter-working function (IWF) or media gateway (MGW) that converts a PSTN call into a VoIP call. It should be noted that alternate network architectures may implement similar functionality.

FIG. 2 depicts a protocol stack 200 used for a VoIP call between VoIP phone 110 and UE 140 in accordance with the prior art. Protocol stack 200 includes an Adaptive Multi-Rate (AMR) layer 205, a Real Time Protocol/Real Time Control Protocol (RTP/RTCP) layer 210, a UDP Lite/IP version 6 (UDP/IPv6) layer 215, a Packet Data Convergence Protocol (PDCP) layer 220, a Radio Link Control (RLC) layer 225, a Medium Access Control (MAC) layer 230, and a Physical (PHY) layer 235.

AMR layer 205, RTP/RTCP layer 210 and UDP/IPv6 layer 215 are implemented at VoIP phone 110. PDCP layer 220 are implemented at RAN 160. RLC layer 225 and MAC layer 230 are implemented at RNC 170. And PHY layer 235 is implemented at Node B 180. Note that although UDP/IPv6 layer 215 is being shown as a single layer, its actual implementation would probably be as two separate UDP Lite and IPv6 layers.

For illustration purposes, suppose speech information is being sent from VoIP phone 110 to UE 140. At VoIP phone 110, speech is encoded in AMR layer 205 (via an AMR codec) to produce a speech frame having speech bits. The speech bits can be divided into three classes according to subjective or perceptual importance. The first class, i.e., class A bits, includes speech bits which are most sensitive to errors. Any error to class A bits typically results in a corrupted speech frame which should not be decoded without applying appropriate error correction, such as error concealment or masking. The second class, i.e., class B bits, includes speech bits which are less sensitive to errors than the class A bits but more sensitive to errors than the third class, i.e., class C bits.

In RTP/RTCP layer 210, one or more speech frames are encapsulated into a RTP packet with a RTP header that indicates a sequence number and a time stamp to aid in reordering the speech frames properly at the receiving end. In UDP/IPv6 layer 215, a UDP Lite header and an IPv6 header are added to one or more RTP packets to produce an UDP/IPv6 packet. Specifically, in UDP/IPv6 layer 215, the UDP Lite header is added to the RTP packet to produce a UDP Lite packet. Afterwards, the IP header is added to UDP Lite packet to produce the UDP/IPv6 packet.

The IPv6 header includes an IP address. The UDP Lite header includes a source port, destination port, length indicator and a UDP checksum. The UDP checksum provides error detection for a certain portion of the UDP/IPv6 packet referred to herein as a “UDP checksum portion”. Typically, the UDP checksum portion would include the source port, destination port, IP address and, in most cases, a portion of the RTP packet(s). The length indicator indicates the portion of RTP packet(s) covered by the UDP checksum. If an error occurs with the UDP checksum portion, the error may be detected and some form of error correction may be implemented. Note that the portion of the UDP/IPv6 packet not covered by the UDP checksum is referred to herein as a “non-UDP checksum portion”.

The UDP/IPv6 packet is sent from VoIP phone 110 through internet 105 to GGSN 120. From GGSN 120, the UDP/IPv6 packet is forwarded to core network 130 where it is processed by the remaining layers 220, 225, 230 and 235.

FIGS. 3 and 4 depict examples of UDP Lite packets 300 and 400. In FIG. 3, UDP Lite packet 300 includes a RTP packet with an AMR speech frame encoded at a 7.95 kbps rate. This speech frame includes 75 class A bits (i.e., a₀ to a₇₄) and 84 class B bits (i.e., b₀ to b₈₃). In this example, the UDP checksum portion would include class A bits but not the class B. Thus, the length indicator would indicate the portion of RTP packet corresponding to the 75 class A bits and RTP header.

In FIG. 4, UDP Lite packet 400 includes a RTP packet with an AMR speech frame encoded at a 12.2 kbps rate. The speech frame includes 81 class A bits (i.e., a₀ to a₈₀), 103 class B bits (i.e., b₀ to b₁₀₂) and 60 class C bits (i.e., c₀ to c₅₉). In this example, the UDP checksum portion would include the class A bits but not the class B or C bits. Thus, the length indicator would indicate the portion of the RTP packet corresponding to the 81 class A bits and RTP header.

As described above, the length indicator is used to distinguish the UDP checksum portion from the non-UDP checksum portion of the UDP Lite packet and, thus, allowing for two different levels of QoS to be applied to the payload, e.g., speech frame. However, it may be sometimes desirable to be able to apply more than two different levels of QoS to the payload. For example, suppose different levels of QoS are desired for the class B and C bits, in addition to the class A bits. In such a situation, applying more than two different levels of QoS to the payload would not be possible using UDP Lite as the transport layer. Accordingly, there exist a need to process the payload such that more than two different levels of QoS may be applied.

### SUMMARY OF THE INVENTION

The present invention is a method for applying a differentiated Quality of Service (QoS) to a payload using a profile indicator that can identify or be used to identify portions of the payload having different QoS requirements. The profile indicator may be one or more length indicators for indicating the lengths of each portion of the payload, or it may be an index to a table which indicates the lengths of each portion of the payload. In one embodiment, the table can be used to map the profile indicator to a number of portions in the packet, the lengths of each portion and a QoS requirement for each portion. Advantageously, the present invention can be implemented as a minor change to the current UDP Lite transport protocol such that the other layers in the protocol stack are unaffected or minimally affected.

### BRIEF DESCRIPTION OF THE DRAWINGS

The features, aspects, and advantages of the present invention will become better understood with regard to the following description, appended claims, and accompanying drawings where:

FIG. 1 depicts a Universal Mobile Telecommunications System (UMTS) based wireless communications system, the internet and a Voice over Internet Protocol (VoIP) phone in accordance with the prior art;

FIG. 2 depicts a protocol stack used for a VoIP call between in accordance with the prior art;

FIGS. 3 and 4 examples of User Datagram Protocol (UDP) Lite packets;

FIG. 5 depicts a protocol stack having with a Differentiated Quality of Service Transport Protocol (DQTP) as its transport layer in accordance with one embodiment of the invention; and

FIG. 6 depicts an example DQTP packet generated by using DQTP in accordance with one embodiment of the invention.

### DETAILED DESCRIPTION

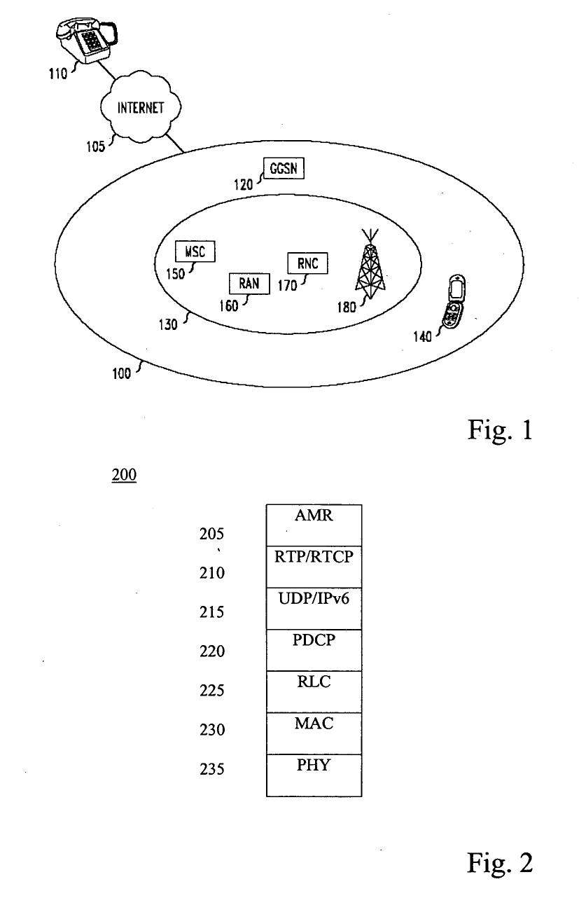

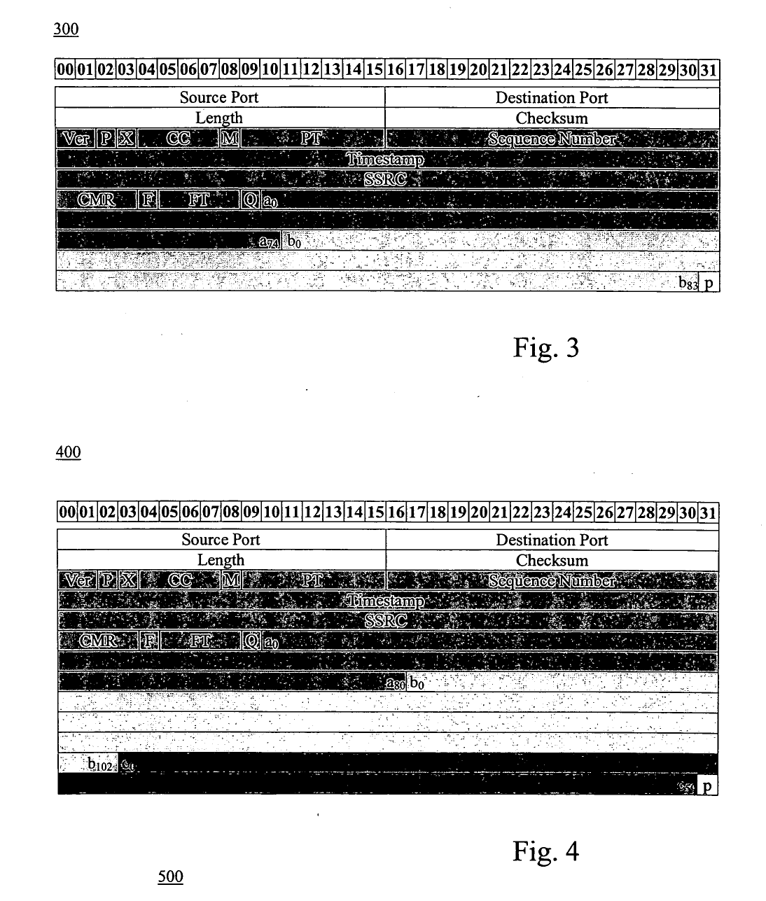

The present invention is a transport layer and a method thereof for applying a differentiated Quality of Service (QoS) to a payload using a profile indicator that can identify or be used to identify portions of the payload having different QoS requirements. The present invention will be described herein with respect to the well-known Universal Mobile Telecommunications System (UMTS) based wireless communications system shown in FIG. 1 and described in the background section. It should be understood that the present invention is also applicable to other types of communications systems including those based on the well-known Code Division Multiple Access (CDMA), Time Division Multiple Access (TDMA) and Orthogonal Frequency Multiple Access (OFDM) technologies. It should be further understood that the principles described herein will be applicable to connection-oriented or connectionless-oriented protocols.

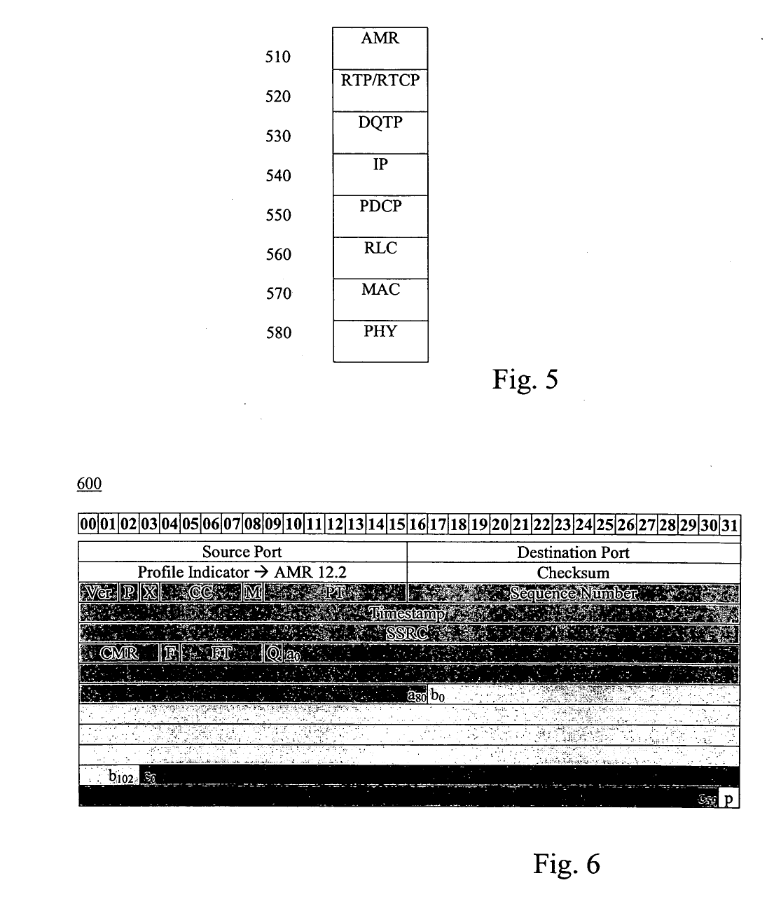

In one embodiment, the present invention transport layer, referred to herein as Differentiated QoS Transport Protocol (DQTP), can be implemented as a minor change to the current UDP Lite transport protocol. Such embodiment advantageously can be easily implemented without requiring modifications or minor modifications to any other layer of a protocol stack. FIG. 5 depicts a protocol stack 500 having DQTP as its transport layer in accordance with this embodiment of the invention. Protocol stack 500 includes an Adaptive Multi-Rate (AMR) layer 510, a Real Time Protocol/Real Time Control Protocol (RTP/RTCP) layer 520, a DQTP layer 530, an Internet Protocol (IP) layer 540, a Packet Data Convergence Protocol (PDCP) layer 550, a Radio Link Control (RLC) layer 560, a Medium Access Control (MAC) layer 570, and a Physical (PHY) layer 580. AMR layer 510, RTP/RTCP layer 520, PDCP layer 550, RLC layer 560, MAC layer 570 and PHY layer 580 being essentially the same in function as described above for AMR layer 205, RTP/RTCP layer 210, PDCP layer 220, RLC layer 225, MAC layer 230 and PHY layer 235 in protocol stack 200, respectively. IP layer 540, in this embodiment, can either be IP network layer version 4 or 6. It should be noted that voice coders other than AMR, such as Enhanced Variable Rate Codec (EVRC) and Enhanced Full Rate (EFR) codec, can be used in protocol stack 500.

The main difference between protocol stack 500 of this present invention embodiment and prior art protocol stack 200 is the transport layer. In protocol stack 500, the transport layer is DQTP. By contrast, the transport layer for prior art protocol stack 200 is UDP Lite. This embodiment of DQTP can be implemented as a minor change to UDP Lite. Specifically, DQTP would be exactly the same as UDP Lite except that DQTP would add a profile indicator to the RTP packet instead of a length indicator. The profile indicator being operable to indicate more than two portions. For example, the profile indicator can indicate a packet as having three portions by only indicating the lengths of two portions. The third portion can be assumed to be the remaining portion to be the part of the packet not included in the first and second portions. Or, the profile indicator can indicate a packet as having three portions by only indicating the lengths of all three portions.

The profile indicator may be one or more length indicators for indicating the lengths of each portion of the payload, or it may be an index to a table which indicates the lengths of each portion of the payload. If the profile indicator is one or more length indicators, then there should be some common understanding as to what the QoS requirements are for each portion. For example, the first portion may be understood to have a higher QoS requirement than the second portion, which may be understood to have a higher QoS requirement than the third portion, etc. Alternately, the profile indicator may, in addition to the length indicators, include some indication of the QoS requirements associated with each portion.

If the profile indicator is an index to a table which indicates the lengths of each portion of the payload, then the table could also include a mapping to QoS requirements for each portion of the payload. In one embodiment, the profile indicator can be mapped to a table to determine a number of portions, the lengths of each portion and a QoS requirement for each portion. Alternately, in the absence of a QoS mapping, there could exist some common understanding as to what the QoS requirements are for each portion.

In DQTP layer 530, a DQTP header is added to one or more RTP packet(s) to produce a DQTP packet. Subsequently, in IP layer 540, an IP header is added to the DQTP packet produce an IP packet. The IP header includes an IP address. The DQTP header includes the profile indicator, a source port, a destination port and a DQTP checksum. The DQTP checksum provides error detection for a certain portion of the IP packet referred to herein as a “DQTP checksum portion”. Typically, the DQTP checksum portion would include the source port, destination port, IP address and, in most cases, a portion of the RTP packet(s). The profile indicator indicates the portion of RTP packet(s) covered by the DQTP checksum. If an error occurs with the DQTP checksum portion, the error may be detected and some form of error correction may be implemented. Note that the portion of the IP packet not covered by the DQTP checksum is referred to herein as a “non-DQTP checksum portion”.

FIG. 6 depicts an example DQTP packet 600 generated by DQTP layer 530. Similar to UDP packet 400, DQTP packet 600 includes a RTP packet with an AMR speech frame encoded at a 12.2 kbps rate. The speech frame includes 81 class A bits (i.e., a₀ to a₈₀), 103 class B bits (i.e., b₀ to b₁₀₂) and 60 class C bits (i.e., c₀ to c₅₉). Unlike UDP packet 400, DQTP packet includes a profile indicator rather than a length indicator. In this example, the DQTP checksum portion might include the first portion, or some other portion, indicated by the profile indicator. The non-DQTP checksum portion can be further divided into a first, second, etc. non-DQTP checksum portion depending on how many portions. Such portions are also indicated by the profile indicator. For example, if the profile indicator may indicate the lengths of three or four portions (depending on how it would be understood), then the DQTP packet would comprise of the DQTP checksum portion and a first, second and third non-DQTP checksum portion.

Note that in a preferred embodiment, the profile indicator comprises two bytes (making it the same size as the length indicator of UDP Lite). Advantageously, by making the profile indicator equal in size to the UDP Lite length indicator, less modifications or no modifications to other layers of the protocol stack would be necessary. A Radio Resource Controller (RRC) in RNC 170 selects a set of possible transport formats. MAC layer 570 would look to the same two bytes to identify the portions of the DWTP packet and then selects specific transport formats (from the set of possible transport formats) for each of the portions according to the QoS requirements associated therewith for each transmission. As mentioned earlier, the QoS requirements for each portion can be based on some common understanding (such as, apriori knowledge) or the profile indicator. In PHY layer 580, the selected transport formats are applied to each portion of the DQTP Packet using the profile indicator to identify the portions. Transmitting the DQTP packet after applying the selected transport formats.

The present invention has been described herein with reference to certain embodiment. This should not be construed to limit the present invention to the embodiments described herein. Therefore, the spirit and scope of the present invention should not be limited to the description of the embodiments contained herein.

1. A method for processing a packet comprising the steps of:
adding a first header to the packet at a transport layer of a protocol stack, the header having a profile indicator operable to identify more than two portions of the packet having different Quality of Service (QoS) requirements.

2. The method of claim 1 comprising the additional step of:
adding a second header to the packet at a network layer of the protocol stack, the second header having an Internet Protocol (IP) address.

3. The method of claim 1 comprising, wherein the profile indicator includes at least n length indicators for identifying n+1 portions of the packet, wherein n is greater than or equal to two.

4. The method of claim 3, wherein the profile indicator indicates at least n QoS requirements for at least n portions of the packet.

5. The method of claim 1 comprising, wherein the profile indicator includes at least n length indicators for identifying n portions of the packet, wherein n is greater than or equal to three.

6. The method of claim 5, wherein the profile indicator indicates QoS requirements for each portion of the packet.

7. The method of claim 1, wherein the profile indicator is an index to a table for mapping the index to one or more length indicators for identifying portions of the packet.

8. The method of claim 7, wherein the index can be further mapped to the table to determine a number of portions in the packet have different QoS requirements.

9. The method of claim 8, wherein the index can be further mapped to the table to determine QoS requirements associated with each portion.

10. The method of claim 7, wherein the index can be further mapped to the table to determine QoS requirements associated with each portion.

11. The method of claim 1, wherein the first header includes a source port, a destination port and a checksum for providing error detection to the source port, the destination port, an IP address and a portion of the packet.

12. The method of claim 1, wherein the packet includes a speech frame.

13. The method of claim 12, wherein the speech frame includes speech bits encoded with an Adaptive Multi-Rate (AMR) voice coder.

14. The method of claim 1 comprising the additional steps of:
selecting a set of possible transport formats;
selecting specific transport formats from the set of possible transport formats for each portion of the packet according to QoS requirements.

15. The method of claim 14 comprising the additional step of:
applying the selected specific transport formats to each portion of the packet using the profile indicator.

16. The method of claim 15 comprising the additional step of:
transmitting the packet after the selected specific transport formats have been applied.

17. The method of claim 16, wherein the packet is transmitted over a wireless communications network.

18. The method of claim 17, wherein the wireless communications system is based on Universal Mobile Telecommunications System (UMTS) technology.

19. The method of claim 1, wherein the profile indicator is two bytes in size.
